(19) United States
(12) Patent Application Publication
(10) Pub. No.: US 2023/0412346 A1
(43) Pub. Date: Dec. 21, 2023

(54) FEEDBACK-COLLECTION PACKET FOR NETWORK CODING

(71) Applicant: QUALCOMM Incorporated, San Diego, CA (US)

(72) Inventors: Guangyi LIU, San Diego, CA (US); Tien Viet NGUYEN, Bridgewater, NJ (US); Gabi SARKIS, San Diego, CA (US); Kapil GULATI, Belle Mead, NJ (US); Shuanshuan WU, San Diego, CA (US)

(21) Appl. No.: 17/808,074

(22) Filed: Jun. 21, 2022

(51) Int. Cl. H04L 5/00; H04W 72/06

(52) U.S. Cl. CPC H04L 5/0055; H04W 72/06

(57) ABSTRACT

The apparatus may be configured to receive a plurality of indications for a plurality of TBs for the network encoding device to retransmit and to transmit, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests. The apparatus may also be configured to receive, from at least one of the plurality of UEs, feedback associated with the FCNC request based on the FCNC feedback configuration and to encode, based on the received feedback, the plurality of TBs in at least one NC packet for transmission to the plurality of UEs.

### TECHNICAL FIELD

The present disclosure relates generally to communication systems, and more particularly, to a groupcast or broadcast communication and more specifically to network coding.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network encoding device at a UE or a base station. The apparatus may be configured to receive a plurality of indications for a plurality of transport blocks (TBs) for the network encoding device to retransmit. The apparatus may further be configured to transmit, to a plurality of user equipments (UEs), a feedback collection network coding (FCNC) request for a subset of the plurality of TBs for collecting feedback information regarding the subset of the plurality of TBs, the FCNC request being a network coding (NC) packet including a second indication that the NC packet is associated with an FCNC feedback configuration, the FCNC feedback configuration being different from a feedback configuration for NC packets that are not FCNC requests. The apparatus may also be configured to receive, from at least one of the plurality of UEs, feedback associated with the FCNC request based on the FCNC feedback configuration and to encode, based on the received feedback, the plurality of TBs in at least one NC packet for transmission to the plurality of UEs.

In an aspect of the disclosure, a method, a computer-readable medium, and an apparatus are provided. The apparatus may be a device at a UE. The apparatus may be configured to receive, from a network encoding device, a FCNC request for a subset of a plurality of TBs for collecting feedback information regarding the subset of the plurality of TBs, the FCNC request being a NC packet including a first indication that the NC packet is associated with an FCNC feedback configuration, the FCNC feedback configuration being different from a feedback configuration for NC packets that are not FCNC requests. The apparatus may further be configured to transmit, to the network encoding device, feedback associated with the FCNC request based on the FCNC feedback configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the disclosure.

FIG. 2A is a diagram illustrating an example of a first subframe within a 5G NR frame structure, in accordance with various aspects of the disclosure.

FIG. 2B is a diagram illustrating an example of DL channels within a 5G NR subframe, in accordance with various aspects of the disclosure.

FIG. 2C is a diagram illustrating an example of a second subframe within a 5G NR frame structure, in accordance with various aspects of the disclosure.

FIG. 2D is a diagram illustrating an example of UL channels within a 5G NR subframe, in accordance with various aspects of the disclosure.

FIG. 3 is a block diagram of a base station in communication with a UE in an access network, in accordance with various aspects of the disclosure.

FIG. 4 includes diagrams and illustrating example aspects of slot structures that may be used for sidelink communication, in accordance with various aspects of the disclosure.

FIGS. 5A, 5B, and 5C illustrate example diagrams of wireless communication including transmissions that may be retransmitted as a network coding transmission, in accordance with various aspects of the present disclosure.

FIG. 6 illustrates an example time diagram showing resources for staggered feedback across multiple slots for a network coding transmission, in accordance with various aspects of the present disclosure.

FIG. 7 illustrates an example communication flow between an encoding device and one or more UEs that may include a feedback collection network coding request and/or packet.

FIG. 8 includes a first diagram illustrating a set of PSFCH resources associated with a FCNC packet and a second diagram illustrating a set of UEs identifying PSFCH resources for providing feedback.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an apparatus.

FIG. 14 is a diagram illustrating an example of a hardware implementation for an apparatus.

FIG. 15 is a diagram illustrating an example of a hardware implementation for an apparatus.

### DETAILED DESCRIPTION

Network coding may increase system capacity and improve resource utilization by reducing the number of individual retransmissions, while maintaining system performance by providing the combined retransmission of multiple packets in the network coding transmission. Resources are used more efficiently, because two resources would be used for individual retransmissions, whereas a single resource can be used for the network coded transmission. The network encoded retransmission of multiple packets may enable an increase in the number of transmitters (e.g., UEs) or in the amount of traffic per transmitter (e.g., per UE). As well, the reliability of the communication may be improved, because the receiving UEs may use information from previously received packets in the network coding transmission to decode one or more packets that were not correctly received in the initial transmission. Instead of simply relaying packets of information the encoding device may take multiple packets and combine them together for transmission. The combination of packets may improve information flow in a network by providing information regarding each of the combined packets that may allow UEs that did not receive either one of the combined packets to derive the packet that it failed to receive from the combination of packets. In some aspects, the receiving UEs may provide feedback (e.g., ACK/NACK feedback) to the encoding device for the network encoded transmission.

In the case of groupcasting, an encoding device may receive indications of a plurality of packets for which it is responsible for retransmission. The encoding device, initially, may not have sufficient ACK/NACK information for all, or any, of the plurality of packets. The ACK/NACK information may not be sufficient if the expected number of NACK-to-ACK flips using network coding is smaller than a constant, K, that may be known (preconfigured) or configured. In some aspects, the encoding device may run out of ACK/NACK information. The PSFCH resources for feedback from receiving UEs to the network encoding device, in some aspects, may be limited.

Aspects presented herein provide a way for an encoding device to collect feedback (e.g., ACK/NACK) information regarding the plurality of packets. The encoding device may select a subset of the plurality of packets for transmission in a feedback collection network coding (FCNC) request. In some aspects, the FCNC request includes an indication that the FCNC request is associated with a FCNC feedback configuration. The FCNC feedback configuration, in some aspects, may be different from a feedback configuration for NC packets that are not FCNC requests. For example, a configuration for feedback associated with the FCNC request may be different than a configuration for feedback associated with a NC packet that is not an FCNC request. The feedback configuration associated with the FCNC request may indicate a number of shared feedback resources (e.g., bins) for providing feedback related to each TB in the subset of the plurality of TBs. A receiving device may be configured to identify and/or select a particular shared feedback resource based on identifiers associated with the receiving device.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

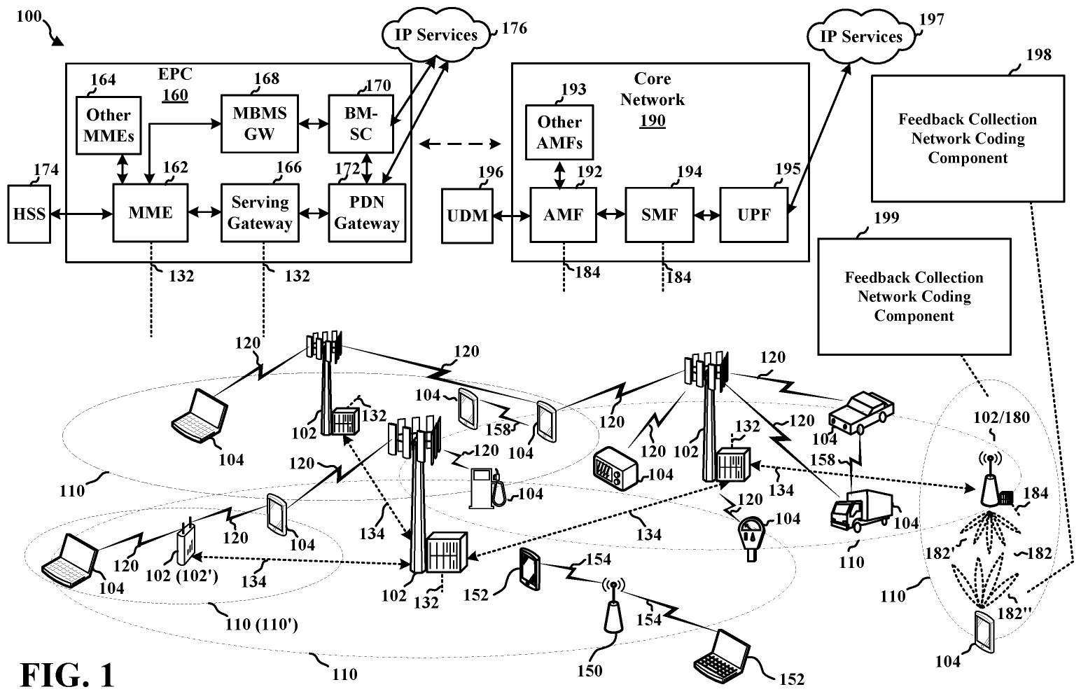

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a feedback collection network coding component 198 that may be configured to receive a plurality of indications for a plurality of TBs for the network encoding device to retransmit. The feedback collection network coding component 198 may further be configured to transmit, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests. The feedback collection network coding component 198 may also be configured to receive, from at least one of the plurality of UEs, feedback associated with the FCNC request based on the FCNC feedback configuration and to encode, based on the received feedback, the plurality of TBs in at least one NC packet for transmission to the plurality of UEs. The feedback collection network coding component 198 may be configured to receive, from a network encoding device, a FCNC request for a subset of a plurality of TBs for collecting feedback information regarding the subset of the plurality of TBs, the FCNC request being a NC packet including a first indication that the NC packet is associated with an FCNC feedback configuration, the FCNC feedback configuration being different from a feedback configuration for NC packets that are not FCNC requests. The feedback collection network coding component 198 may further be configured to transmit, to the network encoding device, feedback associated with the FCNC request based on the FCNC feedback configuration.

In certain aspects, the base station 180 may include a feedback collection network coding component 199 that may be configured to receive a plurality of indications for a plurality of TBs for the network encoding device to retransmit. The feedback collection network coding component 199 may further be configured to transmit, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests. The feedback collection network coding component 199 may also be configured to receive, from at least one of the plurality of UEs, feedback associated with the FCNC request based on the FCNC feedback configuration and to encode, based on the received feedback, the plurality of TBs in at least one NC packet for transmission to the plurality of UEs. Although the following description may be focused on 5G NR, the concepts described herein may be applicable to other similar areas, such as LTE, LTE-A, CDMA, GSM, and other wireless technologies.

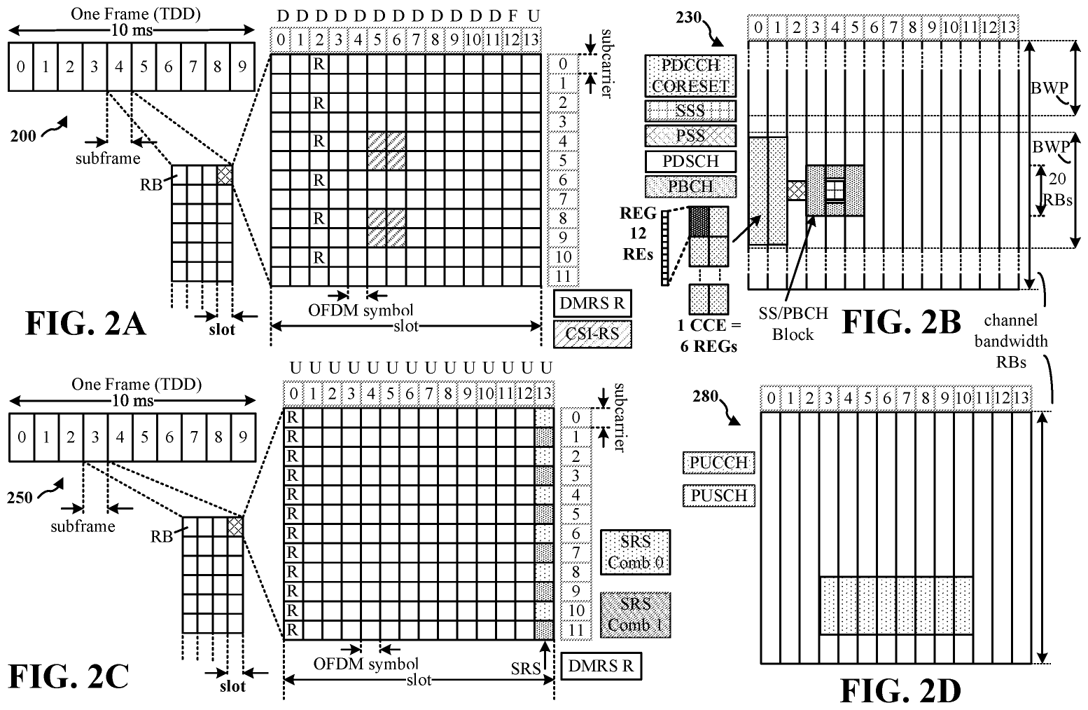

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| | Δf = 2^{μ} · 15 | Cyclic |
| μ | [KHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

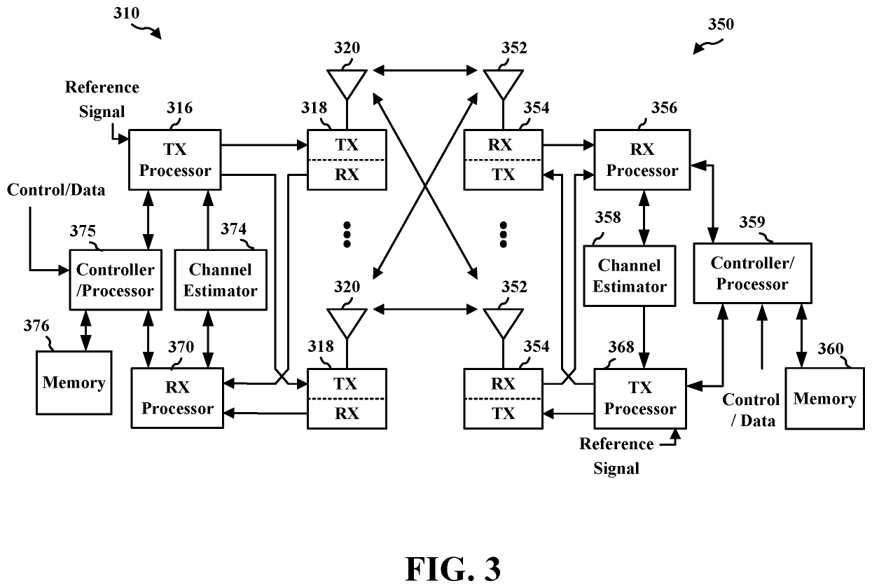

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

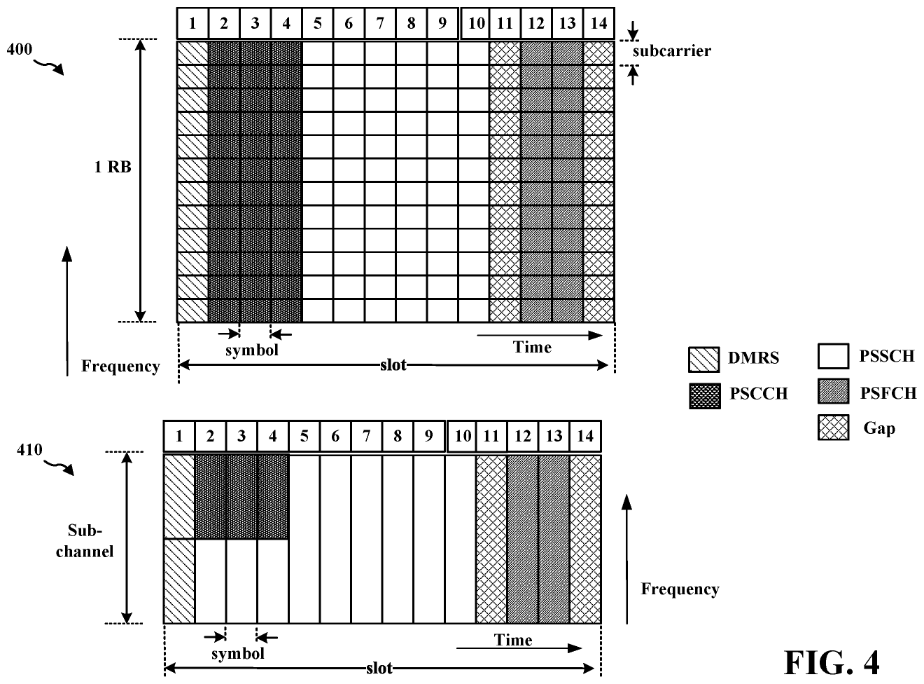

FIG. 4 includes diagrams 400 and 410 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 4. Multiple slots may be aggregated together in some aspects.

The reliability of communication between a transmitting device and a receiving device may be improved through network coding of the communication by an encoding device.

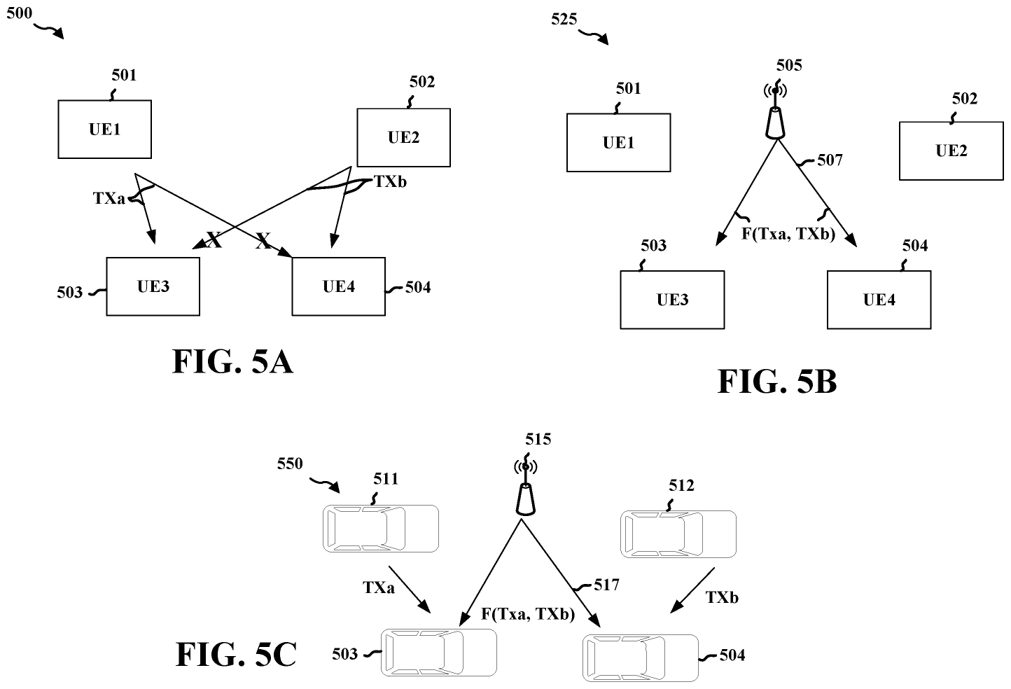

As an example, two or more original transmissions, e.g., two or more initial packets, may be combined through network coding and transmitted as a combination of the initial packets. In an example, a first device may transmit a first packet to a second device, and the second device may transmit a second packet to the first device. Following the transmission of the first and second packets, the encoding device may transmit an encoded combination of the first and second packets, e.g., based on network coding. Each of the devices may decode the packet from the other device in the network coded combination of the packets, with assistance based on the information of their own packet. For example, at the first device, the knowledge of the first packet may assist the first device in decoding the second packet from the network coded transmission of the first and second packet. FIGS. 5A and 5B illustrate another example application of network coding.

FIG. 5A illustrates an example of wireless communication 500 in which a first wireless device (e.g., UE 501) transmits a first transmission TXa, and a second wireless device (e.g., UE 502) transmits a second transmission TXb. A third wireless device (e.g., UE 503) correctly receives the first transmission TXa, but does not correctly receive the second transmission TXb. A fourth wireless device (e.g., UE 504) correctly receives the second transmission TXb, but does not correctly receive the first transmission TXa. The diagram 525 in FIG. 5B illustrates that after the original transmissions of TXa and TXb in FIG. 5A, an encoding device 505 may transmit a transmission 507 that includes a network coding combination of the first transmission TXa and the second transmission TXb. For example, the transmission 507 may be a function of the first transmission TXa and the second transmission TXb, e.g., F(TXa, TXb). The encoding device may be a base station, an RSU, a UE, and IAB node, etc. In some aspects, the original transmissions TXa and TXb may be sidelink transmissions. The UE 503 may use the transmission TXa that it previously received, e.g., as illustrated in FIG. 5A to assist in decoding the second transmission TXb from the transmission 507. The UE 504 may use the transmission TXb that it previously received, e.g., as illustrated in FIG. 5A to assist in decoding the first transmission TXa from the transmission 507. Although this example illustrates two transmissions, the network coding may combine more than two packets in the combined transmission 507. Network coding may improve a network's throughput, efficiency and scalability. Network coding may increase system capacity and improve resource utilization by reducing the number of individual retransmissions, while maintaining system performance by providing the combined retransmission of multiple packets in the network coding transmission. Additionally, resources may be used more efficiently, because two resources would be used for individual retransmissions of TXa and TXb, whereas a single resource can be used for the network coded transmission 507. The network encoded retransmission of multiple packets may enable an increase in the number of transmitters (e.g., UEs) or in the amount of traffic per transmitter (e.g., per UE). As well, the reliability of the communication may be improved, because the receiving UEs may use information from previously received packets in the network coding transmission 507 to decode one or more packets that were not correctly received in the initial transmission. Instead of simply relaying packets of information the encoding device 505 may take multiple packets and combine them together for transmission. The combination of packets may improve information flow in a network.

In some aspects, network coding, including the aspects presented herein, may be applied for sidelink communication, such as V2X communication. Additionally, or alternatively, the network coding aspects described herein may be applied for non-vehicular sidelink communication. The network coding aspects may also be applied for other types of wireless communication than sidelink. FIG. 5C illustrates an example of network coding 550 similar to FIGS. 5A and 5B for V2X communication. In FIG. 5C, a first UE 511 transmits a first transmission TXa, and a second UE 512 transmits a second transmission TXb. An encoding device 515 may transmit a network coded retransmission 517 of both TXa and TXb, e.g., as described in connection with FIG. 5B. The UEs 503 and 504 may attempt to receive the initial transmissions of TXa and TXb, and may use the network coded retransmission 517 to accurately receive TXa and/or TXb. The encoding device 515 may be an RSU, a base station, or another UE.

The encoding device 505 or 515 may identify two or more packets (e.g., original packet(s) TXa and TXb) for transmitting to the receiving device(s) (e.g., 503 and 504). The encoding device 505 or 515 applies a network coding algorithm to the original packets to generate encoded packets (e.g., 507). The encoding device 505 may then transmit the encoded packets (e.g., 507) as a data transmission.

The receiving device(s) (e.g., 503 and 504) may then attempt to decode the received encoded packets (e.g., 507) to reconstruct the original packets (e.g., TXa and TXb).

In some examples, to improve communication between a transmitting device (e.g., any of UE 501, UE 502, and/or encoding device 505) and the receiving device (e.g., 503 and 504), the receiving device may transmit feedback, such as ACK/NACK feedback, that indicates whether a packet has been received accurately. For example, the UE 503 in FIG. 5A may transmit an ACK for TXa and a NACK for TXb, whereas the UE 504 may transmit a NACK for TXa and an ACK for TXb. In some aspects, the UE 501 and the UE 502 may respond to the NACK by retransmitting their respective transmissions. In the example in FIG. 5B, the encoding device 505 may use the feedback to determine which packets to re-transmit with network coding, e.g., at 507.

In some aspects, the encoding device may provide retransmissions for many UEs and may prioritize which packets to retransmit among multiple initial transmissions from multiple UEs. The encoding device may use feedback, e.g., ACK/NACK feedback, to select a subset of packets (or encoded transport block) to include in a network coding transmission. A transport block (TB) is a packet of data that is mapped onto a data channel (e.g., a physical sidelink shared channel (PSSCH), a physical uplink shared channel (PUSCH), a physical downlink shared channel (PDSCH), etc.) for transmission. A transport block may refer to a payload for a physical layer data transmission. In some aspects, the encoding device may select the TBs, or packets, to network encode as a retransmission in order to maximize the change in feedback from NACKs to ACKs. For example, the encoding device may consider the feedback from multiple UEs for multiple packets and may select combinations of packets to network encode that have a higher likelihood of successful receipt. Table 1 illustrates an example of ACK/NACK feedback that may be provided by four UEs (e.g., UE0, UE1, UE2 and UE3) for four packets (e.g., p0, p1, p2, and p3).

TABLE 1

| Receiving | | | | |
|---|---|---|---|---|
| UE | p0 | p1 | p2 | p3 |
| UE0 | ACK | NACK | ACK | |
| UE1 | ACK | ACK | NACK | NACK |
| UE2 | NACK | ACK | ACK | ACK |
| UE3 | ACK | NACK | | ACK |

Table 1 illustrates that the UE0 successfully received p0 and p2, and did not successfully receive p1. The empty cell for p3 indicates absent feedback. The UE1 successfully received p0 and p1, and did not successfully receive p2 and p3. The UE 2 did not successfully receive p0, and successfully received p1, p2, and p3. The UE3 successfully received p0 and p3, did not successfully receive p1, and has absent feedback for p2. The encoding device (e.g., which may also be referred to as an encoder) may assume an ACK for each packet's source UE. Thus, if a fifth UE transmitted p0 and p2, the chart may include an ACK for p0 and p1 for the fifth UE even though the fifth UE does not provide feedback, because the fifth UE is the source of the packets.

Table 2 illustrates an example of possible combinations of packets that the encoding device may transmit with network coding and shows a corresponding indication for the set of four UEs in Table 1 showing the status for the combined packets.

TABLE 2

| Receiving UE | p0 + p1 | p0 + p2 | p0 + p3 | P1 + p2 | p1 + p3 | p2 + p3 |
|---|---|---|---|---|---|---|
| UE0 | ✓ | A | | ✓ | X | |
| UE1 | A | ✓ | ✓ | ✓ | ✓ | X |
| UE2 | ✓ | ✓ | ✓ | A | A | A |
| UE3 | ✓ | | A | | X | |

In Table 2, an “A” indicates that both packets have been received successfully (e.g., decoded successfully) by the corresponding UE, a check mark indicates that the UE successfully decoded one of the packets and did not successfully decode the other packet, an “X” indicates that neither packet was successfully decoded, and an empty entry means that feedback was not received for at least one of the packets. In Table 2, the combination p0+p1 has a highest likelihood in changing a NACK for one of the packets to ACK for each of the UEs, which may be referred to as a NACK-to-ACK flip. The combination of p0+p1 has the most checkmarks indicating that one packet was already successfully received by the corresponding UEs. Thus, transmitting p0+p1 enables three of the four UEs to decode a previously undecoded packet. The UE1 successfully received both of the packets of the combination p0+p1. As the UE0, UE2, and UE3 have successfully received one of the packets, the UEs may use the information for the received packet to assist the UEs in decoding the other packet from the network coded transmission, which increases the likelihood of successful receipt by the UEs. The encoding device may select the combination of p0+p1 to retransmit with network coding.

While the examples in FIGS. 5A-5C and Tables 1 and 2 illustrate the example of network coding for two packets, the encoding device may combine more than 2 packets in a network coding transmission. For example, the encoding device may combine 2 or more packets, e.g., 2 packets, 3 packets, 4 packets, or more. In some aspects, the encoding device may have insufficient information for determining which combined packets will result in at least an expected number, e.g., a known or configured number K, of NACK-to-ACK flips. The minimum expected number of expected NACK-to-ACK flips, in some aspects, may be a function of a known or configured value K and a bin size associated with a feedback configuration.

Aspects presented herein provide a way to collect information for determining which combined packets will result in an expected number of NACK-to-ACK flips. For example, an encoding device may transmit a feedback collection network coding packet including a subset of the packets (e.g., transport blocks) for which the encoding device is responsible for retransmitting to collect information relating to the subset of packets. The subset of the packets may be included in a plurality of transport blocks of the feedback collection network coding packet.

While the examples in FIGS. 5A-5C and Tables 1 and 2 illustrate the example of network coding for two or four UEs, the encoding device may retransmit packets (e.g., transport blocks) for a large number of UEs, such as hundreds of UEs. As an example, an encoding device with 250 UEs in a communication system may target network coded packets to a subset of the UEs, e.g., to 120 UEs or less. Receiving feedback from each UE in the subset of UEs for every packet in a combination may involve p to 120*4=480 resources, in such an example. The number of resources used to receive individual feedback from each of the UEs in the subset of UEs may be more than is available in a slot or a set of PSFCH resources associated with the feedback from the subset of UEs. The feedback resources, e.g., for a feedback collection network coding packet for the purpose of bootstrapping, may exceed the available feedback resources in the slot or the set of PSFCH resources associated with the feedback from the subset of UEs. Bootstrapping may refer to soliciting feedback for the packets, for example.

Aspects presented herein further provide a way to collect feedback information for a plurality of receiving devices in a limited number of feedback (e.g., PSFCH) resources by configuring shared feedback resources (e.g., bins) that may be used by multiple receiving devices. The shared feedback resources, in some aspects may be dynamically configured or known (preconfigured).

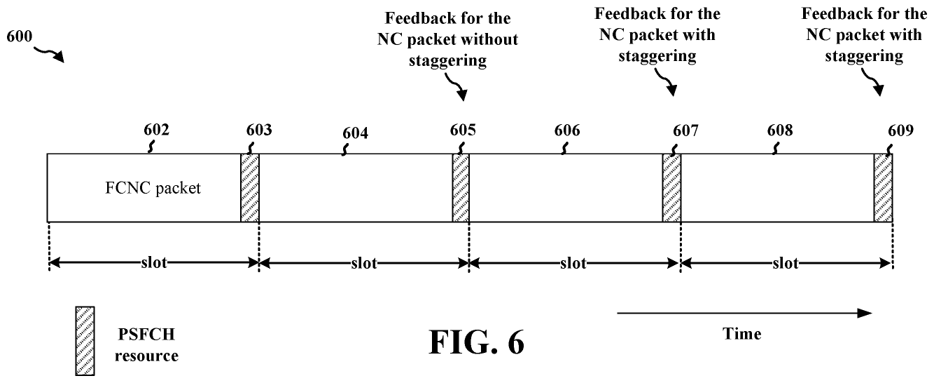

FIG. 6 illustrates an example time diagram 600 showing the transmission of a network coding transmission in a first slot 602. If feedback is sent without staggering, the feedback may be transmitted in feedback resources 605 of a second slot 604. FIG. 6 illustrates that the first slot 602 may include feedback resources 603, in which feedback may be received for transmissions in prior slots. With staggered feedback across multiple slots, one of more UEs may send feedback in the feedback resources 607 of a third slot 606 and/or feedback resources 609 of a fourth slot 608. As an example, a baseline set of resources for feedback for the encoded transmission in the first slot 602 may be the feedback resources 605 in the following slot (e.g., the second slot 604) As illustrated in FIG. 6, each slot may include PSFCH resources, e.g., as described in connection with FIG. 4. The PSFCH resources in a slot may include one or more symbols of resources. The aspects, presented herein may be used for feedback sent with staggering or without staggering.

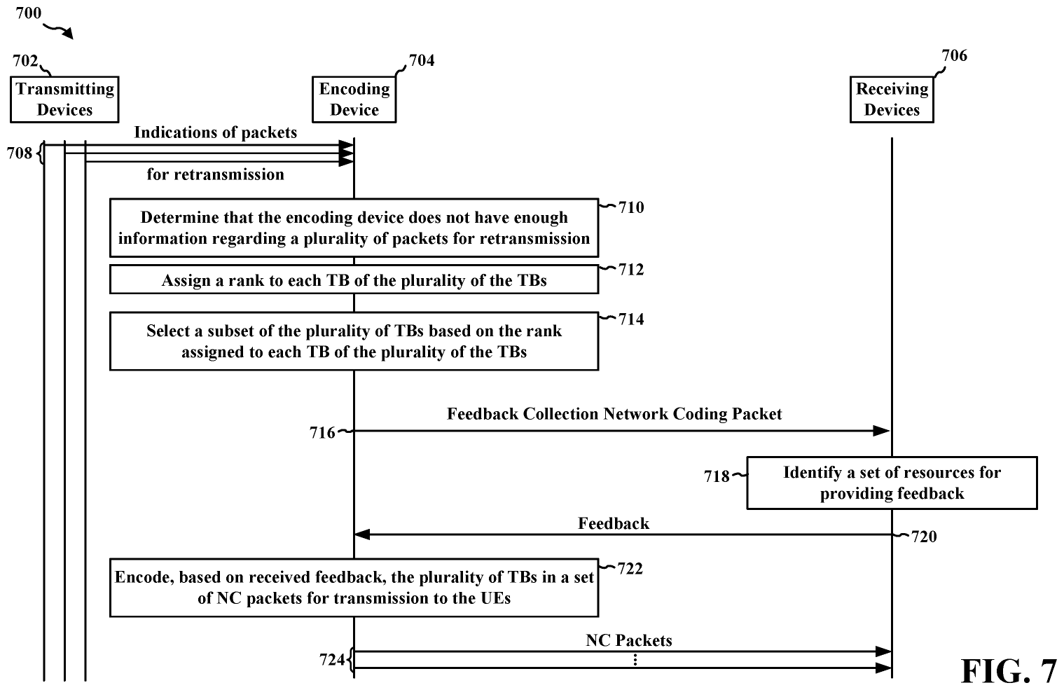

FIG. 7 illustrates an example communication flow 700 between an encoding device 704 and one or more UEs, e.g., transmitting devices 702 and receiving devices 706 that may include a feedback collection network coding request and/or packet. For example, each device, e.g., a UE such as a mobile device, a vehicle, etc., in the set of transmitting devices 702 may transmit an indication of a packet for retransmission 708 to the encoding device 704. The encoding device 704 may determine 710 that the encoding device does not have enough information regarding the plurality of packets for retransmission. After determining 710 that the encoding device 704 does not have enough information regarding the plurality of packets for retransmission, the encoding device 704 may assign 712 a rank to each TB in the plurality of TBs. The rank assigned 712 by the encoding device may be based on at least one of an expiration time associated with the TB, a priority associated with the TB, a location of a source of the TB, a TB size, or a TB range specification. For example, in some aspects, a rank may be based on a weighted average calculated based on two or more of the expiration time associated with the TB, the priority associated with the TB, the location of a source of the TB, the TB size, or the TB range specification.

Based on the rank assigned 712 by the encoding device 704, the encoding device 704 may select 714 a subset of the plurality of TBs based on the rank assigned 712 to each TB of the plurality of the TBs. In some aspects, the encoding device 704 may select 714 the subset of the plurality of TBs randomly. The selection 714 may be based on an identification of a number of TBs (e.g., a maximum number of TBs) that may be included in the subset. The (maximum) number of TBs may be based on an amount of feedback resources (e.g., PSFCH resources) available for receiving feedback. The subset of the plurality of TBs selected 714 by the encoding device, in some aspects, may include the plurality of TBs if the maximum number of TBs is greater than the number of TBs in the plurality of TBs for retransmission.

The encoding device 704 may then transmit, and the receiving devices 706 may receive, a feedback collection network coding packet (request) 716. The feedback collection network coding packet may include an indication that the packet is a feedback collection network coding request associated with a FCNC feedback configuration. The FCNC feedback configuration, in some aspects, may be different from a feedback configuration for NC packets that are not FCNC requests. For example, the FCNC feedback configuration may indicate for a receiving device to provide feedback to the encoding device via a different PSFCH resource than for NC packets that are not FCNC requests or may indicate a different method for determining a PSFCH resource for providing feedback to the encoding device than for NC packets that are not FCNC requests. The indication may include a bit in the header of the FCNC request. The FCNC feedback configuration, in some aspects, includes a third indication of a first number of shared feedback resources (e.g., bins). In some aspect, the first number of shared feedback resources (e.g., bins) is associated with each TB in the subset of TBs included in the FCNC request. In some aspects, each of the shared feedback resources is associated with a different subset of UEs in a plurality of UEs (the receiving devices 706) and the first number of shared feedback resources is smaller than a number of UEs in the plurality of UEs.

Based on receiving the feedback collection network coding packet (request) 716, the receiving devices 706 may identify 718 a set of resources for providing feedback to the encoding device 704. The set of resources may include a feedback resource associated with each TB in the subset of TBs included in the feedback collection network coding packet (request) 716. The feedback resources associated with the feedback collection network coding packet (request) 716 may be divided into a set of resource pools corresponding to the TBs in the subset of TBs. Each resource pool associated with a TB may be further subdivided into a first number of bins (shared feedback resources) that may be selected by a receiving device for providing feedback. The number of bins may be known (e.g., preconfigured) or signaled by the encoding device. A number, N_{B}, of bins may be determined based on a number, N_{P}, of available PSFCH resources and a number, N_{T}, of TBs in the subset of TBs, such that N_{B}*N_{T}≤N. In some aspects, the number, N_{B}, of bins may be one of (1) the largest integer smaller than N_{P}/N_{T}, (2) a largest number of bins in a known (preconfigured) set of candidate values for the number of bins, or (3) a default value unless the default value is larger than N_{P}/N_{T}. The number of bins, N_{B}, may be smaller than a number of bins used for other NC packets based on the inclusion of more TBs in the FCNC request than in other NC packets.

The particular resources in the set of resources identified 718 by the receiving devices 706 may be based on one or more of a packet ID associated with the subset of TBs (e.g., to identify a resource pool associated with the TB), a device ID, a zone ID, a beam ID, or other identifier associated with the receiving device that may be different for different devices associated with a same encoding device. For example, the receiving devices 706 may, for each TB in the subset of TBs, determine a resource pool associated with the TB and then perform a hashing function of one or more of the device ID, the zone ID, the beam ID, or the other ID to identify a particular resource in the resource pool. In other aspects, the receiving device may use other methods of identifying a corresponding bin known to one of ordinary skill in the art.

Based on the received feedback collection network coding packet (request) 716, the receiving devices 706 may transmit feedback 720 via the identified 718 set of resources. The encoding device 704 may receive the feedback 720 from the receiving devices 706 along with feedback from a plurality of receiving devices via the PSFCH resources including the identified 718 set of resources such that the feedback from multiple receiving devices may be received via a same PSFCH resource for one or more TBs in the subset of TBs. The received feedback may provide sufficient information regarding the TBs in the subset of TBs to the encoding device to determine that a certain number, K, of NACK-to-ACK flips may be expected based on a network coding packet including a combination of packets including one or more of the TBs in the subset of TBs.

Based on the feedback 720 received from the receiving devices 706, the encoding device 704 may determine which of the plurality of TBs to combine in a subsequent set of NC packets. The encoding device 704 may encode 722, based on the received feedback 720, the plurality of TBs into a set of NC packets 724 for transmission to receiving devices. Each packet in the set of NC packets 724 may include a set of TBs that each include information related to a combination of two or more TBs in the plurality of TBs that the encoding device is responsible for retransmitting. The set of NC packets 724 may be standard NC packets (e.g., NC packets that are not FCNC requests) and the feedback configuration associated with the NC packets 724 may be different than the feedback configuration associated with the feedback collection network coding packet (request) 716.

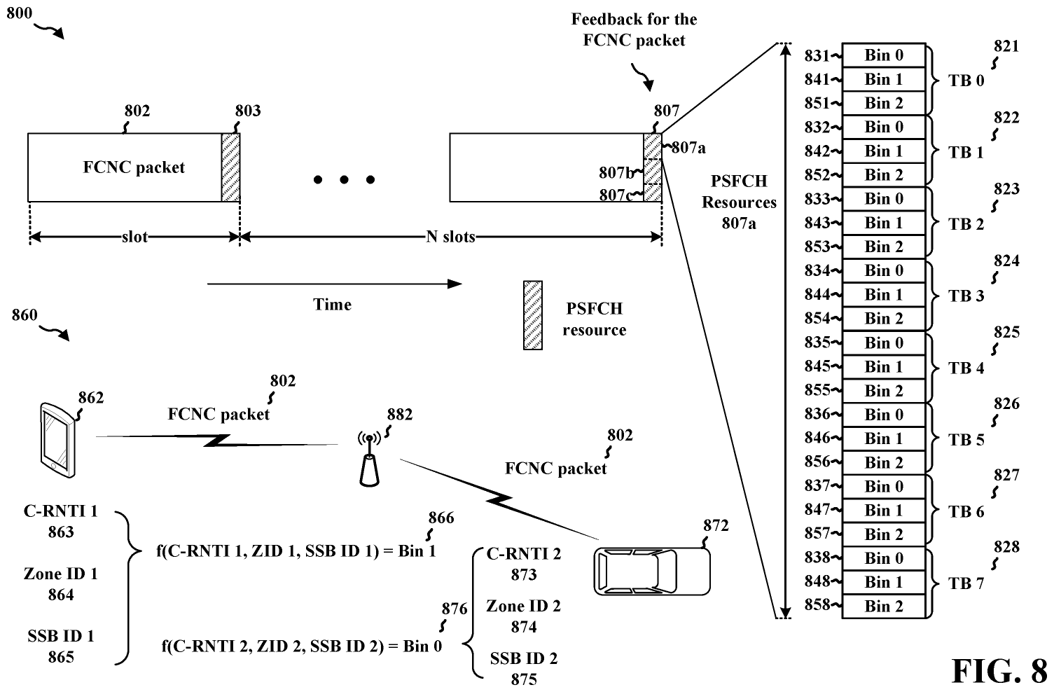

FIG. 8 includes a first diagram 800 illustrating a set of PSFCH resources associated with a FCNC packet 802 and a second diagram 860 illustrating first UE 862 and second UE 872 identifying PSFCH resources for providing feedback. Diagram 800 illustrates that PSFCH resources 803 and 807 may be included in slots with a periodicity of N slots with N being, e.g., one to four slots. In diagram 800, N may be three slots such that the PSFCH resources 807 may be divided into three resource pools 807a, 807b, and 807c corresponding to the three slots associated with the PSFCH resource 807. The resource pool 807a associated with the FCNC packet 802 may further be subdivided into resource pools 821-828 associated with a set of eight TBs (e.g., TB 0 to TB 7) that may be included in the FCNC packet. Each of the resource pools 821-828 may be further subdivided into shared feedback resources (e.g., bins 831, 841, and 851).

Diagram 860 illustrates that a base station 882 (e.g., as an example of an encoding device) may communicate the FCNC packet 802 with a first UE 862 and a second UE 872. The first UE 862 may be associated with a first set of identifiers including C-RNTI 1 863, Zone ID 1 864, and SSB ID 1 865 that may be used to determine a shared feedback resource “Bin 1” 866. The second UE 872 may be associated with a second set of identifiers including C-RNTI 2 873, Zone ID 2 874, and SSB ID 2 875 that may be used to determine a shared feedback resource “Bin 0” 876. The shared feedback resource may be determined based on a hashing function applied to one or more of the identifiers associated with the UEs or based on a modulo (based on the number of bins) applied to one or more identifiers. In some aspects, a same shared feedback resource (e.g., bin) may be used by a UE for providing feedback for each TB in the subset of TBs included in the FCNC packet 802.

The specific resources associated with a particular shared feedback resource (bin) may be determined based on the number of TBs included in the FCNC packet 802 and the amount of resources in the PSFCH resource pool 807a associated with the FCNC packet 802. Similarly, the number, N_{B}, of bins may be determined based on a number, N_{P}, of available PSFCH resources and a number, N_{T}, of TBs in the FCNC packet 802, such that N_{B}*N_{T}≤N. In some aspects, the number, N_{B}, of bins may be one of (1) the largest integer smaller than N_{P}/N_{T}, (2) a largest number of bins in a known (preconfigured) set of candidate values for the number of bins, or (3) a default value unless the default value is larger than N_{P}/N_{T}. The feedback configuration for the FCNC packet 802 may be different from a feedback configuration for a NC packet that is not a FCNC packet based on the increased number of TBs included in the FCNC packet 802 such that for a NC packet that is not a FCNC packet each resource pool for a TB is larger and can be subdivided into a larger number of bins.

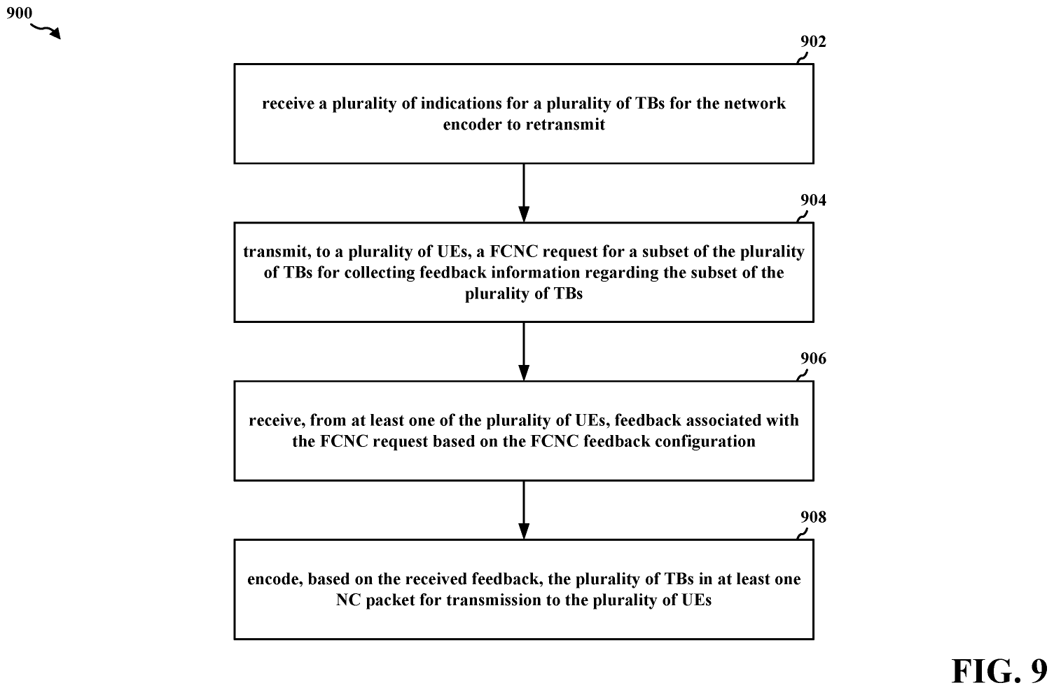

FIG. 9 is a flowchart 900 of a method of wireless communication. The method may be performed by an encoding device (e.g., the UE 104; the encoding device 704; the apparatus 1302; the base station 102/180, 505, 515, and 882; the apparatus 1402). At 902, the encoding device may receive a plurality of indications for a plurality of TBs for the network encoding device to retransmit. For example, 902 may be performed by packet retransmission identification component 1340 or by packet retransmission identification component 1440. The plurality of TBs may include TBs that a set of other devices (UEs, the base station, etc.) have determined that the encoding device should be responsible for retransmitting. For example, referring to FIG. 7, the encoding device 704 may receive the plurality of indications of packets for retransmission 708. The encoding device may not have sufficient ACK/NACK information for the plurality of TBs or a group of TBs in the plurality of TBs. In some aspects, not having sufficient ACK/NACK information may mean that there is insufficient information to determine that a threshold number of NACK-to-ACK flips is expected based on a transmission of a first NC packet including a combination of TBs from the subset of the plurality of TBs. The threshold number of NACK-to-ACK flips may be one of a known (preconfigured) threshold value, or a lesser of the known threshold value and a value dependent upon a number of shared feedback resources (bins) used to receive the feedback associated with the FCNC request. Based on the insufficient information, the encoding device may determine to transmit a FCNC request to collect ACK/NACK information regarding a subset of the plurality of TBs.

In some aspects, the number of TBs, M, in the plurality of TBs may be larger than can be included in a FCNC request and the encoding device may determine which TBs to include in the FCNC request. In order to determine which TBs to include in the FCNC request, the encoding device may identify a number of TBs in the subset of the plurality of TBs (e.g., the number of TBs that may be included in a FCNC request) based on available resources for feedback (e.g., PSFCH resources). In some aspects, the encoding device may assign a rank to each TB of the plurality of the TBs. The rank assigned to each TB of the plurality of TBs is based on at least one of an expiration time associated with the TB, a priority associated with the TB, a location of a source of the TB, a TB size, or a TB range specification. The encoding device may then select the subset of the plurality of TBs based on the rank assigned to each TB of the plurality of the TBs.

At 904, the encoding device may transmit, to a plurality of receiving devices and/or UEs a FCNC request for the subset of the plurality of TBs for collecting feedback information regarding the subset of the plurality of TBs. For example, 904 may be performed by FCNC transmission component 1344 or by FCNC transmission component 1444. In some aspects, the FCNC request may be a NC packet including a second indication that the NC packet is associated with an FCNC feedback configuration. The second indication that the NC packet is associated with the FCNC feedback configuration may include a bit in a header of the FCNC request. The FCNC feedback configuration, in some aspects, may be different from a feedback configuration for NC packets that are not FCNC requests. For example, referring to FIGS. 7 and 8, the encoding device 704 may transmit the feedback collection network coding packet (request) 716 or the FCNC packet 802 to the receiving devices 706.

The FCNC feedback configuration may include a third indication of a first number of shared feedback resources (bins), where each of the shared feedback resources may be associated with a different subset of receiving devices and/or UEs in the plurality of receiving devices and/or UEs and the first number of shared feedback resources is smaller than a number of receiving devices and/or UEs in the plurality of receiving devices and/or UEs. In some aspects, the first number of shared feedback resources is based on a number of feedback resources available for receiving the feedback from the plurality of UEs and a number of TBs in the subset of the plurality of TBs. The number of bins may be known (e.g., preconfigured) or signaled by the encoding device. In addition to signaling the number of bins, the FCNC request may include an indication of a method for a receiving device to identify a bin (e.g., a specific resource in a set of PSFCH resources) for providing feedback. A number, N_{B}, of bins may be determined based on a number, N_{P}, of available PSFCH resources and a number, N_{T}, of TBs in the subset of TBs, such that N_{B}*N_{T}≤N. In some aspects, the first number, N_{B}, of bins may be one of (1) a largest integer that is smaller than the number of feedback resources available for receiving feedback from the plurality of UEs divided by the number of transport blocks in the subset of the plurality of TBs (e.g., N_{P}/N_{T}), (2) a largest value in a set of values that is smaller than the number of feedback resources available for receiving feedback from the plurality of UEs divided by the number of transport blocks in the subset of the plurality of TBs, or (3) a threshold value if the number of feedback resources available for receiving feedback from the plurality of UEs divided by the number of transport blocks in the subset of the plurality of TBs is greater than the threshold value.

At 906, the encoding device may receive, from at least one of the plurality of receiving devices and/or UEs feedback associated with the FCNC request based on the FCNC feedback configuration. For example, 906 may be performed by FCNC feedback reception component 1346 or by FCNC feedback reception component 1446. The feedback may be based on a feedback configuration indicated in a FCNC request. For example, referring to FIGS. 7 and 8, the encoding device 704 may receive feedback 720 from one or more receiving devices 706 based on a PSFCH configuration as illustrated in diagram 800. The received feedback may provide sufficient ACK/NACK information for determining that a threshold number of NACK-to-ACK flips is expected based on a transmission of a first NC packet including a combination of TBs from the subset of the plurality of TBs.

Finally, at 908, the encoding device may encode, based on the received feedback, the plurality of TBs in at least one NC packet for transmission to the plurality of receiving devices and/or UEs. For example, 908 may be performed by NC encoding component 1348 or by NC encoding component 1448. The combinations of TBs in the plurality of TBs combined in each NC packet may be selected to such that a number of expected NACK-to-ACK flips is above a threshold or is maximized. For example, referring to FIG. 7, the encoding device 704 may encode 722 the plurality of TBs in a set of NC packets for transmission to the plurality of receiving devices and/or UEs. The encoding device may then transmit the encoded set of NC packets 724 to the receiving devices 706.

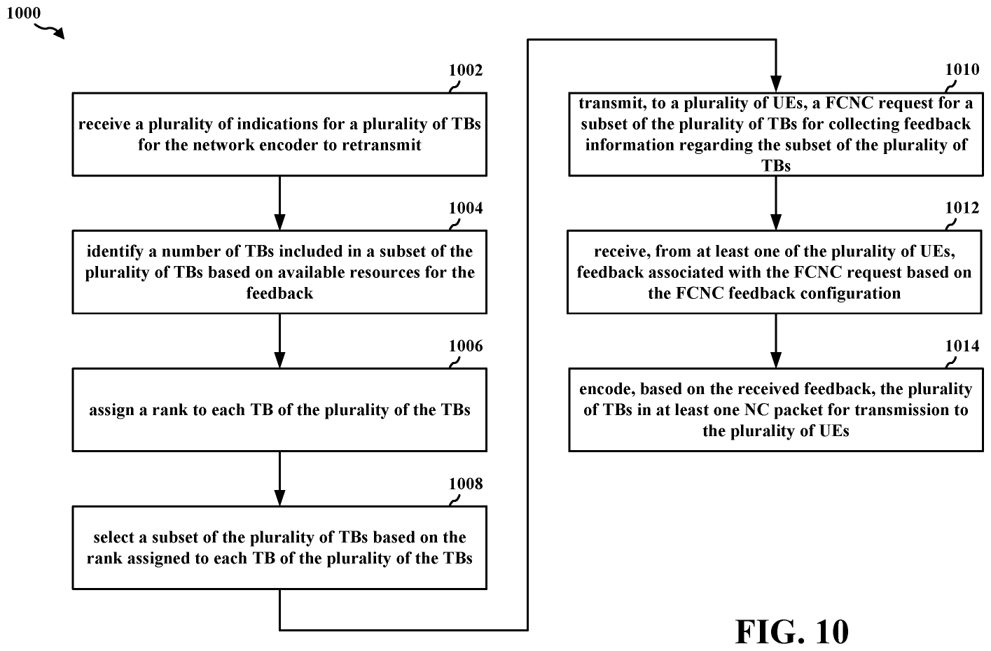

FIG. 10 is a flowchart 1000 of a method of wireless communication. The method may be performed by an encoding device (e.g., the UE 104; the encoding device 704; the apparatus 1302; the base station 102/180, 505, 515, and 882; the apparatus 1402). At 1002, the encoding device may receive a plurality of indications for a plurality of TBs for the network encoding device to retransmit. For example, 1002 may be performed by packet retransmission identification component 1340 or by packet retransmission identification component 1440. The plurality of TBs may include TBs that a set of other devices (UEs, the base station, etc.) have determined that the encoding device should be responsible for retransmitting. For example, referring to FIG. 7, the encoding device 704 may receive the plurality of indications of packets for retransmission 708. The encoding device may not have sufficient ACK/NACK information for the plurality of TBs or a group of TBs in the plurality of TBs. In some aspects, not having sufficient ACK/NACK information may mean that there is insufficient information to determine that a threshold number of NACK-to-ACK flips is expected based on a transmission of a first NC packet including a combination of TBs from the subset of the plurality of TBs. The threshold number of NACK-to-ACK flips may be one of a known (preconfigured) threshold value, or a lesser of the known threshold value and a value dependent upon a number of shared feedback resources (bins) used to receive the feedback associated with the FCNC request. Based on the insufficient information, the encoding device may determine to transmit a FCNC request to collect ACK/NACK information regarding a subset of the plurality of TBs.

In some aspects, the number of TBs, M, in the plurality of TBs may be larger than can be included in a FCNC request and the encoding device may determine which TBs to include in the FCNC request. In order to determine which TBs to include in the FCNC request, the encoding device may identify, at 1004, a number of TBs in the subset of the plurality of TBs (e.g., the number of TBs that may be included in a FCNC request) based on available resources for feedback (e.g., PSFCH resources). For example, 1004 may be performed by FCNC TB selection component 1342 or by FCNC TB selection component 1442. For example, referring to FIG. 7, the encoding device 704 may identify a (maximum) number of TBs that may be included in the feedback collection network coding packet (request) 716 as part of selection 714.

At 1006, the encoding device may assign a rank to each TB of the plurality of the TBs. For example, 1006 may be performed by FCNC TB selection component 1342 or by FCNC TB selection component 1442. The rank assigned to each TB of the plurality of TBs, in some aspects, may be based on at least one of an expiration time associated with the TB, a priority associated with the TB, a location of a source of the TB, a TB size, or a TB range specification. In some aspects, a rank may be based on a weighted average calculated based on two or more of the expiration time associated with the TB, the priority associated with the TB, the location of a source of the TB, the TB size, or the TB range specification. For example, referring to FIG. 7, the encoding device 704 may assign 712 a rank to each TB of the plurality of TBs.

At 1008, the encoding device may then select the subset of the plurality of TBs based on the rank assigned to each TB of the plurality of the TBs. For example, 1008 may be performed by FCNC TB selection component 1342 or by FCNC TB selection component 1442. The selected subset of the plurality of TBs may be a number of TBs identified, at 1004, as the number of TBs to be included in the FCNC request with the highest rank as assigned at 1006. The selected subset of the plurality of TBs, in some aspects, may be a number of TBs less than the number of TBs identified, at 1004, as a maximum number of TBs to be included in the FCNC request with an assigned, at 1006, rank that is higher than a threshold. In some aspects, the encoding device 704 may select 714 the subset of the plurality of TBs randomly. For example, referring to FIG. 7, the encoding device 704 may select 714 a subset of the plurality of TBs based on the rank assigned 712 to each TB of the plurality of the TBs.

At 1010, the encoding device may transmit, to a plurality of receiving devices and/or UEs a FCNC request for the subset of the plurality of TBs for collecting feedback information regarding the subset of the plurality of TBs. For example, 1010 may be performed by FCNC transmission component 1344 or by FCNC transmission component 1444. In some aspects, the FCNC request may be a NC packet including a second indication that the NC packet is associated with an FCNC feedback configuration. The second indication that the NC packet is associated with the FCNC feedback configuration may include a bit in a header of the FCNC request. The FCNC feedback configuration, in some aspects, may be different from a feedback configuration for NC packets that are not FCNC requests. For example, referring to FIGS. 7 and 8, the encoding device 704 may transmit the feedback collection network coding packet (request) 716 or the FCNC packet 802 to the receiving devices 706.

The FCNC feedback configuration may include a third indication of a first number of shared feedback resources (bins), where each of the shared feedback resources may be associated with a different subset of receiving devices and/or UEs in the plurality of receiving devices and/or UEs and the first number of shared feedback resources is smaller than a number of receiving devices and/or UEs in the plurality of receiving devices and/or UEs. In some aspects, the first number of shared feedback resources is based on a number of feedback resources available for receiving the feedback from the plurality of UEs and a number of TBs in the subset of the plurality of TBs. The number of bins may be known (e.g., preconfigured) or signaled by the encoding device. In addition to signaling the number of bins, the FCNC request may include an indication of a method for a receiving device to identify a bin (e.g., a specific resource in a set of PSFCH resources) for providing feedback. A number, N_{B}, of bins may be determined based on a number, N_{P}, of available PSFCH resources and a number, N_{T}, of TBs in the subset of TBs, such that N_{B}*N_{T}≤N. In some aspects, the first number, N_{B}, of bins may be one of (1) a largest integer that is smaller than the number of feedback resources available for receiving feedback from the plurality of UEs divided by the number of transport blocks in the subset of the plurality of TBs (e.g., N_{P}/N_{T}), (2) a largest value in a set of values that is smaller than the number of feedback resources available for receiving feedback from the plurality of UEs divided by the number of transport blocks in the subset of the plurality of TBs, or (3) a threshold value if the number of feedback resources available for receiving feedback from the plurality of UEs divided by the number of transport blocks in the subset of the plurality of TBs is greater than the threshold value.

At 1012, the encoding device may receive, from at least one of the plurality of receiving devices and/or UEs feedback associated with the FCNC request based on the FCNC feedback configuration. For example, 1006 may be performed by FCNC feedback reception component 1346 or by FCNC feedback reception component 1446. The feedback may be based on a feedback configuration indicated in a FCNC request. For example, referring to FIGS. 7 and 8, the encoding device 704 may receive feedback 720 from one or more receiving devices 706 based on a PSFCH configuration as illustrated in diagram 800. The received feedback may provide sufficient ACK/NACK information for determining that a threshold number of NACK-to-ACK flips is expected based on a transmission of a first NC packet including a combination of TBs from the subset of the plurality of TBs.

Finally, at 1014, the encoding device may encode, based on the received feedback, the plurality of TBs in at least one NC packet for transmission to the plurality of receiving devices and/or UEs. For example, 1008 may be performed by NC encoding component 1348 or by NC encoding component 1448. The combinations of TBs in the plurality of TBs combined in each NC packet may be selected to such that a number of expected NACK-to-ACK flips is above a threshold or is maximized. For example, referring to FIG. 7, the encoding device 704 may encode 722 the plurality of TBs in a set of NC packets for transmission to the plurality of receiving devices and/or UEs. The encoding device may then transmit the encoded set of NC packets 724 to the receiving devices 706.

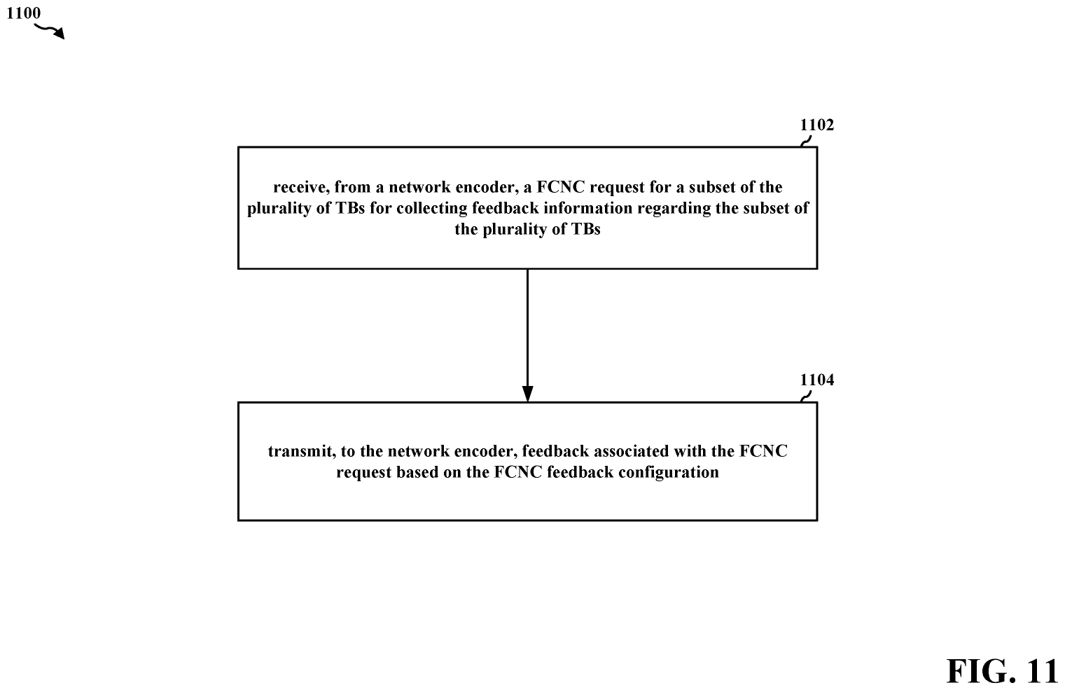

FIG. 11 is a flowchart 1100 of a method of wireless communication. The method may be performed by a receiving device (e.g., the UE 104, 503, or 504; the receiving devices 706; the apparatus 1502). At 1102, the receiving device may receive, from an encoding device, a FCNC request for a subset of the plurality of TBs for collecting feedback information regarding the subset of the plurality of TBs. For example, 1102 may be performed by FCNC reception component 1540. In some aspects, the FCNC request may be a NC packet including a first indication that the NC packet is associated with an FCNC feedback configuration. The first indication that the NC packet is associated with the FCNC feedback configuration may include a bit in a header of the FCNC request. The FCNC feedback configuration, in some aspects, may be different from a feedback configuration for NC packets that are not FCNC requests. For example, referring to FIGS. 7 and 8, a receiving device of the receiving devices 706 may receive the feedback collection network coding packet (request) 716 or the FCNC packet 802 from the encoding device 704.

The FCNC feedback configuration may include a second indication of a first number of shared feedback resources (bins), where each of the shared feedback resources may be associated with a different subset of receiving devices and/or UEs in the plurality of receiving devices and/or UEs and the first number of shared feedback resources is smaller than a number of receiving devices and/or UEs in the plurality of receiving devices and/or UEs. In some aspects, the first number of shared feedback resources is based on a number of feedback resources available for receiving the feedback from the plurality of UEs and a number of TBs in the subset of the plurality of TBs. The number of bins may be known (e.g., preconfigured) or signaled by the encoding device. In addition to signaling the number of bins, the FCNC request may include an indication of a method for a receiving device to identify a bin (e.g., a specific resource in a set of PSFCH resources) for providing feedback. A number, N_{B}, of bins may be determined based on a number, N_{P}, of available PSFCH resources and a number, N_{T}, of TBs in the subset of TBs, such that N_{B}*N_{T}≤N. In some aspects, the first number, N_{B}, of bins may be one of (1) a largest integer that is smaller than the number of feedback resources available for receiving feedback from the plurality of UEs divided by the number of transport blocks in the subset of the plurality of TBs (e.g., N_{P}/N_{T}), (2) a largest value in a set of values that is smaller than the number of feedback resources available for receiving feedback from the plurality of UEs divided by the number of transport blocks in the subset of the plurality of TBs, or (3) a threshold value if the number of feedback resources available for receiving feedback from the plurality of UEs divided by the number of transport blocks in the subset of the plurality of TBs is greater than the threshold value.

At 1104, the receiving device may transmit, to the network encoding device, feedback associated with the FCNC request based on the FCNC feedback configuration. For example, 1104 may be performed by feedback transmission component 1544. Transmitting, at 1104, the feedback associated with the FCNC request may include identifying a set of resources for providing feedback to the encoding device. Identifying the set of resources for providing feedback may include identifying a resource pool associated with each TB in the subset of the plurality of TBs and identifying a shared feedback resource in each resource pool for transmitting feedback regarding an associated TB in the subset of the plurality of TBs. The resource pool associated with each TB may be identified based on a packet identifier associated with the corresponding TB, and the shared feedback resource may be identified based on one or more of a UE identifier, a communication session identifier, a zone identifier, or a beam identifier. For example, referring to FIGS. 7 and 8, a receiving device of the receiving devices 706 or a first UE 862 may identify 718 a set of resources, e.g., one of bins 831-838, bins 841-848, or bins 851-858, based on C-RNTI ID 1 863, Zone ID 1 864, and/or SSB ID 1 865 and transmit feedback 720 via the identified resources.

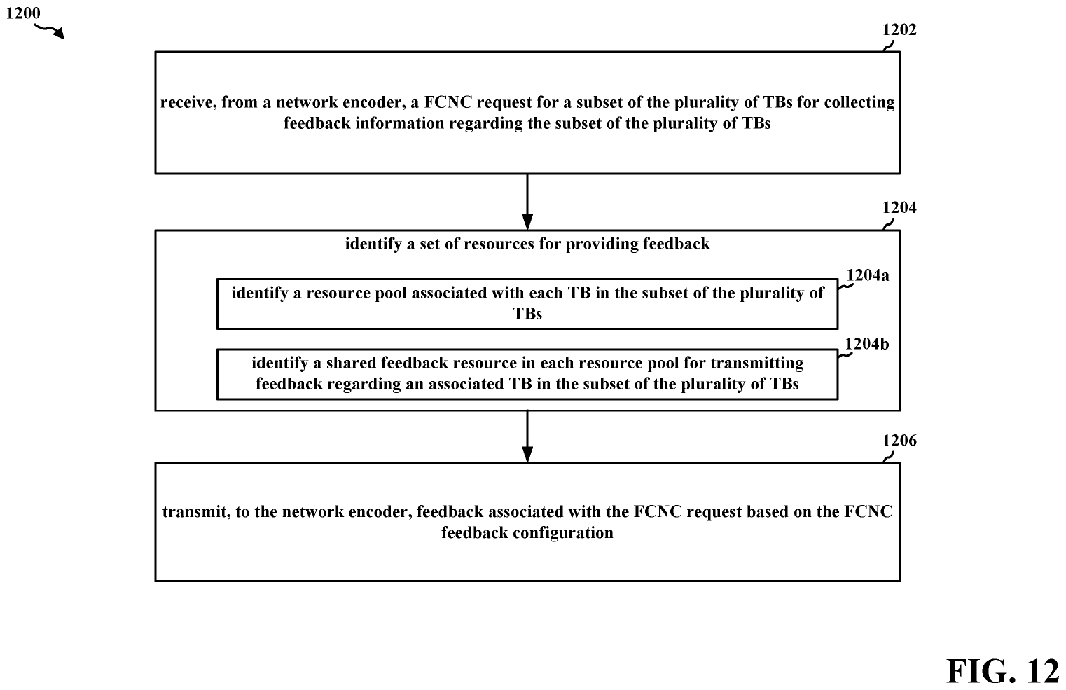

FIG. 12 is a flowchart 1200 of a method of wireless communication. The method may be performed by a receiving device (e.g., the UE 104, 503, or 504; the receiving devices 706; the apparatus 1502). At 1202, the receiving device may receive, from an encoding device, a FCNC request for a subset of the plurality of TBs for collecting feedback information regarding the subset of the plurality of TBs. For example, 1202 may be performed by FCNC reception component 1540. In some aspects, the FCNC request may be a NC packet including a first indication that the NC packet is associated with an FCNC feedback configuration. The first indication that the NC packet is associated with the FCNC feedback configuration may include a bit in a header of the FCNC request. The FCNC feedback configuration, in some aspects, may be different from a feedback configuration for NC packets that are not FCNC requests. For example, referring to FIGS. 7 and 8, a receiving device of the receiving devices 706 may receive the feedback collection network coding packet (request) 716 or the FCNC packet 802 from the encoding device 704.

The FCNC feedback configuration may include a second indication of a first number of shared feedback resources (bins), where each of the shared feedback resources may be associated with a different subset of receiving devices and/or UEs in the plurality of receiving devices and/or UEs and the first number of shared feedback resources is smaller than a number of receiving devices and/or UEs in the plurality of receiving devices and/or UEs. In some aspects, the first number of shared feedback resources is based on a number of feedback resources available for receiving the feedback from the plurality of UEs and a number of TBs in the subset of the plurality of TBs. The number of bins may be known (e.g., preconfigured) or signaled by the encoding device. In addition to signaling the number of bins, the FCNC request may include an indication of a method for a receiving device to identify a bin (e.g., a specific resource in a set of PSFCH resources) for providing feedback. A number, N_{B}, of bins may be determined based on a number, N_{P}, of available PSFCH resources and a number, N_{T}, of TBs in the subset of TBs, such that N_{B}*N_{T}≤N. In some aspects, the first number, N_{B}, of bins may be one of (1) a largest integer that is smaller than the number of feedback resources available for receiving feedback from the plurality of UEs divided by the number of transport blocks in the subset of the plurality of TBs (e.g., N_{P}/N_{T}), (2) a largest value in a set of values that is smaller than the number of feedback resources available for receiving feedback from the plurality of UEs divided by the number of transport blocks in the subset of the plurality of TBs, or (3) a threshold value if the number of feedback resources available for receiving feedback from the plurality of UEs divided by the number of transport blocks in the subset of the plurality of TBs is greater than the threshold value.

At 1204, the receiving device may identify a set of resources for providing feedback to the encoding device. For example, 1204 may be performed by feedback resource identification component 1542. Identifying, at 1204, the set of resources for providing feedback may include identifying, at 1204a, a resource pool associated with each TB in the subset of the plurality of TBs. The resource pool associated with each TB may be identified based on a packet identifier associated with the corresponding TB. The receiving device may additionally identify, at 1204b, a shared feedback resource in each resource pool for transmitting feedback regarding an associated TB in the subset of the plurality of TBs. The shared feedback resource may be identified based on one or more of a UE identifier, a communication session identifier, a zone identifier, or a beam identifier. For example, referring to FIGS. 7 and 8, a receiving device of the receiving devices 706 or a first UE 862 may identify 718 a set of resources, e.g., one of bins 831-838, bins 841-848, or bins 851-858, based on C-RNTI ID 1 863, Zone ID 1 864, and/or SSB ID 1 865.

Finally, at 1206, the receiving device may transmit, to the network encoding device, feedback associated with the FCNC request based on the FCNC feedback configuration. For example, 1206 may be performed by feedback transmission component 1544. Transmitting, at 1204, the feedback associated with the FCNC request may include transmitting the feedback via the set of resources identified at 1204. For example, referring to FIGS. 7 and 8, a receiving device of the receiving devices 706 or a first UE 862 may transmit feedback 720 via the set of identified 718 resources, e.g., one of bins 831-838, bins 841-848, or bins 851-858.

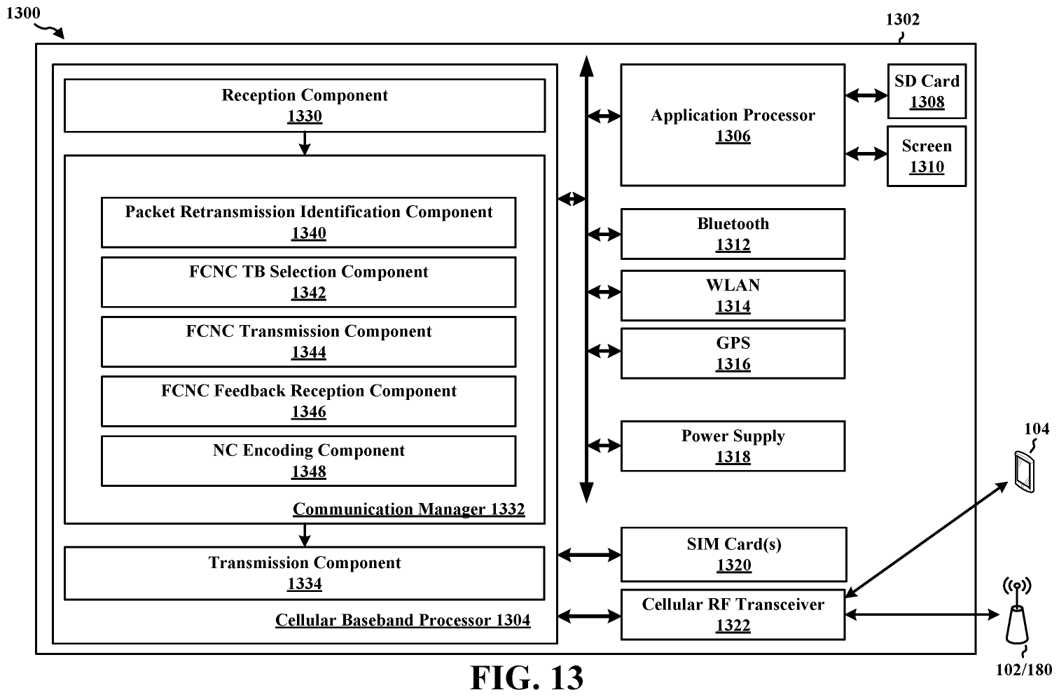

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, or a power supply 1318. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302.

The communication manager 1332 includes a packet retransmission identification component 1340 that is configured to receive a plurality of indications for a plurality of TBs for the network encoding device to retransmit, e.g., as described in connection with 902 and 1002 of FIGS. 9 and 10. The communication manager 1332 further includes a FCNC TB selection component 1342 that is configured to receive input in the form of the plurality of TB from the packet retransmission identification component 1340 and is configured to identify a number of TBs in the subset of the plurality of TBs based on available resources for feedback, assign a rank to each TB of the plurality of the TBs, select the subset of the plurality of TBs based on the rank assigned to each TB of the plurality of the TBs, e.g., as described in connection with 1004, 1006, and 1008 of FIG. 10. The communication manager 1332 further includes a FCNC transmission component 1344 that is configured to receive input in the form of a selected subset of the plurality of TBs from the FCNC TB selection component 1342 and is configured to transmit, to a plurality of UEs, a FCNC request for the subset of the plurality of TBs for collecting feedback information regarding the subset of the plurality of TBs, e.g., as described in connection with 904 and 1010 of FIGS. 9 and 10. The communication manager 1332 further includes a FCNC feedback reception component 1346 that is configured to receive, from at least one of the plurality of UEs, feedback associated with the FCNC request based on the FCNC feedback configuration, e.g., as described in connection with 906 and 1012 of FIGS. 9 and 10. The communication manager 1332 further includes a NC encoding component 1348 that is configured to encode, based on the received feedback, the plurality of TBs in at least one NC packet for transmission to the plurality of UEs, e.g., as described in connection with 908 and 1014 of FIGS. 9 and 10.

The apparatus may include additional components that perform each of the blocks of the algorithm in the flowcharts of FIGS. 9 and 10. As such, each block in the flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, includes means for receiving a plurality of indications for a plurality of TBs for the network encoding device to retransmit. The apparatus 1302, and in particular the cellular baseband processor 1304, may also include means for transmitting, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests. The apparatus 1302, and in particular the cellular baseband processor 1304, may also include means for receiving, from at least one of the plurality of UEs, feedback associated with the FCNC request based on the FCNC feedback configuration. The apparatus 1302, and in particular the cellular baseband processor 1304, may also include means for encoding, based on the received feedback, the plurality of TBs in at least one NC packet for transmission to the plurality of UEs. The apparatus 1302, and in particular the cellular baseband processor 1304, may also include means for assigning a rank to each TB of the plurality of TBs. The apparatus 1302, and in particular the cellular baseband processor 1304, may also include means for selecting the subset of the plurality of TBs based on the rank assigned to each TB of the plurality of TBs. The apparatus 1302, and in particular the cellular baseband processor 1304, may also include means for identifying a number of TBs included in the subset of the plurality of TBs based on available resources for the feedback. The means may be one or more of the components of the apparatus 1302 configured to perform the functions recited by the means. As described supra, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

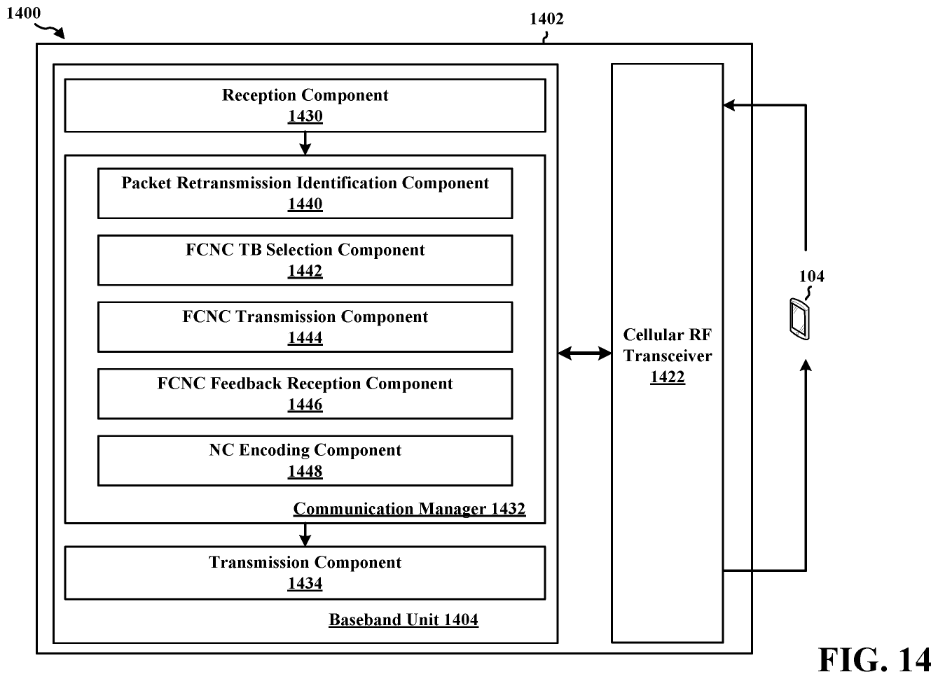

FIG. 14 is a diagram 1400 illustrating an example of a hardware implementation for an apparatus 1402. The apparatus 1402 may be a base station, a component of a base station, or may implement base station functionality. In some aspects, the apparatus 1302 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

The communication manager 1432 includes a packet retransmission identification component 1440 that is configured to receive a plurality of indications for a plurality of TBs for the network encoding device to retransmit, e.g., as described in connection with 902 and 1002 of FIGS. 9 and 10. The communication manager 1432 further includes a FCNC TB selection component 1442 that is configured to receive input in the form of the plurality of TB from the packet retransmission identification component 1440 and is configured to identify a number of TBs in the subset of the plurality of TBs based on available resources for feedback, assign a rank to each TB of the plurality of the TBs, select the subset of the plurality of TBs based on the rank assigned to each TB of the plurality of the TBs, e.g., as described in connection with 1004, 1006, and 1008 of FIG. 10. The communication manager 1432 further includes a FCNC transmission component 1444 that is configured to receive input in the form of a selected subset of the plurality of TBs from the FCNC TB selection component 1442 and is configured to transmit, to a plurality of UEs, a FCNC request for the subset of the plurality of TBs for collecting feedback information regarding the subset of the plurality of TBs, e.g., as described in connection with 904 and 1010 of FIGS. 9 and 10. The communication manager 1432 further includes a FCNC feedback reception component 1446 that is configured to receive, from at least one of the plurality of UEs, feedback associated with the FCNC request based on the FCNC feedback configuration, e.g., as described in connection with 906 and 1012 of FIGS. 9 and 10. The communication manager 1432 further includes a NC encoding component 1448 that is configured to encode, based on the received feedback, the plurality of TBs in at least one NC packet for transmission to the plurality of UEs, e.g., as described in connection with 908 and 1014 of FIGS. 9 and 10.

The apparatus may include additional components that perform each of the blocks of the algorithm in the flowcharts of FIGS. 9 and 10. As such, each block in the flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for receiving a plurality of indications for a plurality of TBs for the network encoding device to retransmit. The apparatus 1402, and in particular the baseband unit 1404, may also include means for transmitting, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests. The apparatus 1402, and in particular the baseband unit 1404, may also include means for receiving, from at least one of the plurality of UEs, feedback associated with the FCNC request based on the FCNC feedback configuration. The apparatus 1402, and in particular the baseband unit 1404, may also include means for encoding, based on the received feedback, the plurality of TBs in at least one NC packet for transmission to the plurality of UEs. The apparatus 1402, and in particular the baseband unit 1404, may also include means for assigning a rank to each TB of the plurality of TBs. The apparatus 1402, and in particular the baseband unit 1404, may also include means for selecting the subset of the plurality of TBs based on the rank assigned to each TB of the plurality of TBs. The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

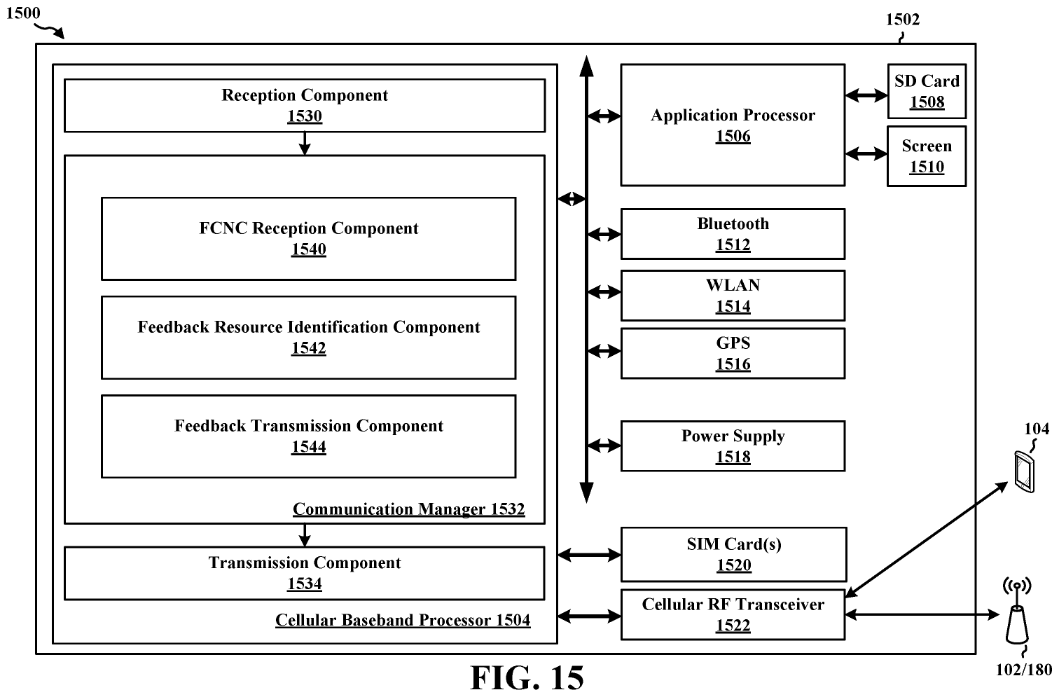

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 includes a FCNC reception component 1540 that is configured to receive, from a network encoding device, a FCNC request for a subset of a plurality of TBs for collecting feedback information regarding the subset of the plurality of TBs, the FCNC request being a NC packet including a first indication that the NC packet is associated with an FCNC feedback configuration, the FCNC feedback configuration being different from a feedback configuration for NC packets that are not FCNC requests, e.g., as described in connection with 1102 and 1202 of FIGS. 11 and 12. The communication manager 1532 further includes a feedback resource identification component 1542 that is configured to receive input in the form of a FCNC request from the FCNC reception component 1540 and is configured to identify a set of resources for transmitting the feedback associated with the FCNC request based on the FCNC feedback configuration, e.g., as described in connection with 1204 of FIG. 12. The communication manager 1532 further includes a feedback transmission component 1544 that is configured to transmit, to the network encoding device, feedback associated with the FCNC request based on the FCNC feedback configuration, e.g., as described in connection with 1104 and 1206 of FIGS. 11 and 12.

The apparatus may include additional components that perform each of the blocks of the algorithm in the flowcharts of FIGS. 11 and 12. As such, each block in the flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, includes means for receiving, from a network encoding device, a FCNC request for a subset of a plurality of TBs for collecting feedback information regarding the subset of the plurality of TBs, the FCNC request being a NC packet including a first indication that the NC packet is associated with an FCNC feedback configuration, the FCNC feedback configuration being different from a feedback configuration for NC packets that are not FCNC requests. The apparatus 1502, and in particular the cellular baseband processor 1504, may also include means for transmitting, to the network encoding device, feedback associated with the FCNC request based on the FCNC feedback configuration. The apparatus 1502, and in particular the cellular baseband processor 1504, may also include means for identifying a set of resources for transmitting the feedback associated with the FCNC request based on the FCNC feedback configuration.

The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

As described above, in some aspects, the encoding device may have insufficient information for determining which combined packets will result in at least an expected number, e.g., a known or configured number K, of NACK-to-ACK flips. The minimum expected number of expected NACK-to-ACK flips, in some aspects, may be a function of a known or configured value K and a bin size associated with a feedback configuration.

Aspects presented herein provide a way to collect information for determining which combined packets will result in an expected number of NACK-to-ACK flips. For example, an encoding device may transmit a feedback collection network coding packet including a subset of the packets (e.g., transport blocks) for which the encoding device is responsible for retransmitting to collect information relating to the subset of packets. The subset of the packets may be included in a plurality of transport blocks of the feedback collection network coding packet.

As described above, the number of resources used to receive individual feedback from each of the UEs in a subset of UEs may be more than is available in a slot or a set of PSFCH resources associated with the feedback from the subset of UEs. The feedback resources, e.g., for a feedback collection network coding packet for the purpose of bootstrapping, may exceed the available feedback resources in the slot or the set of PSFCH resources associated with the feedback from the subset of UEs. Bootstrapping may refer to soliciting feedback for the packets, for example.

Aspects presented herein provide a way to collect feedback information for a plurality of receiving devices in a limited number of feedback (e.g., PSFCH) resources by configuring shared feedback resources (e.g., bins) that may be used by multiple receiving devices. The shared feedback resources, in some aspects may be dynamically configured or known (preconfigured).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to receive a plurality of indications for a plurality of TBs for the network encoding device to retransmit; transmitting, to a plurality of UEs, a FCNC request for a subset of the plurality of TBs for collecting feedback information regarding the subset of the plurality of TBs, the FCNC request being a NC packet including a second indication that the NC packet is associated with an FCNC feedback configuration, the FCNC feedback configuration being different from a feedback configuration for NC packets that are not FCNC requests; receive, from at least one of the plurality of UEs, feedback associated with the FCNC request based on the FCNC feedback configuration; and encode, based on the received feedback, the plurality of TBs in at least one NC packet for transmission to the plurality of UEs.

Aspect 2 is the apparatus of aspect 1, the at least one processor further configured to assign a rank to each TB of the plurality of TBs; and select the subset of the plurality of TBs based on the rank assigned to each TB of the plurality of TBs.

Aspect 3 is the apparatus of aspect 2, where the rank assigned to each TB of the plurality of the TBs is based on at least one of an expiration time associated with the TB, a priority associated with the TB, a location of a source of the TB, a TB size, or a TB range specification.

Aspect 4 is the apparatus of any of aspects 1 to 3, the at least one processor further configured to identify a number of TBs included in the subset of the plurality of TBs based on available resources for the feedback.

Aspect 5 is the apparatus of any of aspects 1 to 4, where the second indication that the NC packet is associated with the FCNC feedback configuration includes a bit in a header of the FCNC request.

Aspect 6 is the apparatus of any of aspects 1 to 5, further including a transceiver couple to the at least one processor, where the FCNC feedback configuration includes a third indication of a first number of shared feedback resources, where each of the shared feedback resources is associated with a different subset of UEs in the plurality of UEs and the first number of shared feedback resources is smaller than a number of UEs in the plurality of UEs.

Aspect 7 is the apparatus of aspect 6, where the first number of shared feedback resources is based on a number of feedback resources available for receiving the feedback from the plurality of UEs and a number of TBs in the subset of the plurality of TBs.

Aspect 8 is the apparatus of aspect 7, where the first number of shared feedback resources is one of: (1) a largest integer that is smaller than the number of feedback resources available for receiving feedback from the plurality of UEs divided by the number of transport blocks in the subset of the plurality of TBs, (2) a largest value in a set of values that is smaller than the number of feedback resources available for receiving feedback from the plurality of UEs divided by the number of transport blocks in the subset of the plurality of TBs, or (3) a threshold value if the number of feedback resources available for receiving feedback from the plurality of UEs divided by the number of transport blocks in the subset of the plurality of TBs is less than the threshold value.

Aspect 9 is the apparatus of any of aspects 1 to 8, where the subset of the plurality of TBs includes one or more TBs for which there is insufficient information to determine that a threshold number of NACK-to-ACK flips is expected based on a transmission of a first NC packet including a combination of TBs from the subset of the plurality of TBs.

Aspect 10 is the apparatus of aspect 9, where the threshold number of NACK-to-ACK flips is one of a known threshold value, or a lesser of the known threshold value and a value dependent upon a number of bins used to receive the feedback associated with the FCNC request.

Aspect 11 is an apparatus for wireless communication including at least one processor coupled to a memory and configured to receive, from a network encoding device, a FCNC request for a subset of a plurality of TBs for collecting feedback information regarding the subset of the plurality of TBs, the FCNC request being a NC packet including a first indication that the NC packet is associated with an FCNC feedback configuration, the FCNC feedback configuration being different from a feedback configuration for NC packets that are not FCNC requests; and transmit, to the network encoding device, feedback associated with the FCNC request based on the FCNC feedback configuration.

Aspect 12 is the apparatus of aspect 11, where the FCNC feedback configuration includes a second indication of a first number of shared feedback resources, where each of the shared feedback resources is associated with a different subset of UEs in a plurality of UEs and the first number of shared feedback resources is smaller than a number of UEs in the plurality of UEs, where the UE is included in the plurality of UEs.

Aspect 13 is the apparatus of any of aspects 11 and 12, where the FCNC feedback configuration includes a second indication of a first number of shared feedback resources, where each of the shared feedback resources is associated with a different subset of UEs in a plurality of UEs and the first number of shared feedback resources is smaller than a number of UEs in the plurality of UEs, where the UE is included in the plurality of UEs

Aspect 14 is the apparatus of aspect 13, where the first number of shared feedback resources is based on a number of feedback resources available for transmitting the feedback and a number of transport blocks in the subset of the plurality of TBs.

Aspect 15 is the apparatus of any of aspects 11 to 14, further including a transceiver coupled to the at least one processor, the at least one processor further configured to identify a set of resources for transmitting the feedback associated with the FCNC request based on the FCNC feedback configuration.

Aspect 16 is the apparatus of aspect 15, where the at least one processor is configured to identify the set of resources by identifying a resource pool associated with each TB in the subset of the plurality of TBs; and identifying a shared feedback resource in each resource pool for transmitting feedback regarding an associated TB in the subset of the plurality of TBs.

Aspect 17 is the apparatus of aspect 16, where the resource pool associated with each TB is identified based on a packet identifier associated with the corresponding TB, and where the shared feedback is identified based on one or more of a UE identifier, a communication session identifier, a zone identifier, or a beam identifier

Aspect 18 is a method of wireless communication for implementing any of aspects 1 to 17.

Aspect 19 is an apparatus for wireless communication including means for implementing any of aspects 1 to 17.

Aspect 20 is a computer-readable medium storing computer executable code, where the code when executed by a processor causes the processor to implement any of aspects 1 to 17.

What is claimed is:

1. An apparatus for wireless communication at a network encoding device, comprising:
a memory; and
at least one processor coupled to the memory and configured to:
receive a plurality of indications for a plurality of transport blocks (TBs) for the network encoding device to retransmit;
transmitting, to a plurality of user equipments (UEs), a feedback collection network coding (FCNC) request for a subset of the plurality of TBs for collecting feedback information regarding the subset of the plurality of TBs, the FCNC request being a network coding (NC) packet comprising a second indication that the NC packet is associated with an FCNC feedback configuration, the FCNC feedback configuration being different from a feedback configuration for NC packets that are not FCNC requests;
receive, from at least one of the plurality of UEs, feedback associated with the FCNC request based on the FCNC feedback configuration; and
encode, based on the received feedback, the plurality of TBs in at least one NC packet for transmission to the plurality of UEs.

2. The apparatus of claim 1, wherein the at least one processor is further configured to:
assign a rank to each TB of the plurality of TBs; and
select the subset of the plurality of TBs based on the rank assigned to each TB of the plurality of TBs.

3. The apparatus of claim 2, wherein the rank assigned to each TB of the plurality of the TBs is based on at least one of an expiration time associated with the TB, a priority associated with the TB, a location of a source of the TB, a TB size, or a TB range specification.

4. The apparatus of claim 1, wherein the at least one processor is further configured to:
identify a number of TBs included in the subset of the plurality of TBs based on available resources for the feedback.

5. The apparatus of claim 1, wherein the second indication that the NC packet is associated with the FCNC feedback configuration comprises a bit in a header of the FCNC request.

6. The apparatus of claim 1, further comprising a transceiver couple to the at least one processor, wherein the FCNC feedback configuration comprises a third indication of a first number of shared feedback resources, wherein each of the shared feedback resources is associated with a different subset of UEs in the plurality of UEs and the first number of shared feedback resources is smaller than a number of UEs in the plurality of UEs.

7. The apparatus of claim 6, wherein the first number of shared feedback resources is based on a number of feedback resources available for receiving the feedback from the plurality of UEs and a number of TBs in the subset of the plurality of TBs.

8. The apparatus of claim 7, wherein the first number of shared feedback resources is one of: (1) a largest integer that is smaller than the number of feedback resources available for receiving feedback from the plurality of UEs divided by the number of TBs in the subset of the plurality of TBs, (2) a largest value in a set of values that is smaller than the number of feedback resources available for receiving feedback from the plurality of UEs divided by the number of TBs in the subset of the plurality of TBs, or (3) a threshold value if the number of feedback resources available for receiving feedback from the plurality of UEs divided by the number of TBs in the subset of the plurality of TBs is less than the threshold value.

9. The apparatus of claim 1, wherein the subset of the plurality of TBs comprises one or more TBs for which there is insufficient information to determine that a threshold number of negative acknowledgement (NACK)-to-acknowledgement (ACK) flips is expected based on a transmission of a first NC packet comprising a combination of TBs from the subset of the plurality of TBs.

10. The apparatus of claim 9, wherein the threshold number of NACK-to-ACK flips is one of a known threshold value, or a lesser of the known threshold value and a value dependent upon a number of bins used to receive the feedback associated with the FCNC request.

11. An apparatus for wireless communication at a user equipment, comprising:
a memory; and
at least one processor coupled to the memory and configured to:
receive, from a network encoding device, a feedback collection network coding (FCNC) request for a subset of a plurality of transport blocks (TBs) for collecting feedback information regarding the subset of the plurality of TBs, the FCNC request being a network coding (NC) packet comprising a first indication that the NC packet is associated with an FCNC feedback configuration, the FCNC feedback configuration being different from a feedback configuration for NC packets that are not FCNC requests; and
transmit, to the network encoding device, feedback associated with the FCNC request based on the FCNC feedback configuration.

12. The apparatus of claim 11, wherein the first indication that the NC packet is associated with the FCNC feedback configuration comprises a bit in a header of the FCNC request.

13. The apparatus of claim 11, wherein the FCNC feedback configuration comprises a second indication of a first number of shared feedback resources, wherein each of the shared feedback resources is associated with a different subset of UEs in a plurality of UEs and the first number of shared feedback resources is smaller than a number of UEs in the plurality of UEs, wherein the UE is included in the plurality of UEs.

14. The apparatus of claim 13, wherein the first number of shared feedback resources is based on a number of feedback resources available for transmitting the feedback and a number of transport blocks in the subset of the plurality of TBs.

15. The apparatus of claim 11, further comprising a transceiver coupled to the at least one processor, wherein the at least one processor is further configured to:
identify a set of resources for transmitting the feedback associated with the FCNC request based on the FCNC feedback configuration.

16. The apparatus of claim 15, wherein the at least one processor is configured to identify the set of resources by:
identifying a resource pool associated with each TB in the subset of the plurality of TBs; and
identifying a shared feedback resource in each resource pool for transmitting feedback regarding an associated TB in the subset of the plurality of TBs.

17. The apparatus of claim 16, wherein the resource pool associated with each TB is identified based on a packet identifier associated with a corresponding TB, and wherein the shared feedback resource is identified based on one or more of a UE identifier, a communication session identifier, a zone identifier, or a beam identifier.

18. A method for wireless communication at a network encoding device, comprising:
receiving a plurality of indications for a plurality of transport blocks (TBs) for the network encoding device to retransmit;
transmitting, to a plurality of user equipments (UEs), a feedback collection network coding (FCNC) request for a subset of the plurality of TBs for collecting feedback information regarding the subset of the plurality of TBs, the FCNC request being a network coding (NC) packet comprising a second indication that the NC packet is associated with an FCNC feedback configuration, the FCNC feedback configuration being different from a feedback configuration for NC packets that are not FCNC requests;
receiving, from at least one of the plurality of UEs, feedback associated with the FCNC request based on the FCNC feedback configuration; and
encoding, based on the received feedback, the plurality of TBs in at least one NC packet for transmission to the plurality of UEs.

19. The method of claim 18, further comprising:
assigning a rank to each TB of the plurality of TBs; and
selecting the subset of the plurality of TBs based on the rank assigned to each TB of the plurality of TBs.

20. The method of claim 19, wherein the rank assigned to each TB of the plurality of the TBs is based on at least one of an expiration time associated with the TB, a priority associated with the TB, a location of a source of the TB, a TB size, or a TB range specification.

21. The method of claim 18, further comprising:
identifying a number of TBs included in the subset of the plurality of TBs based on available resources for the feedback.

22. The method of claim 18, wherein the second indication that the NC packet is associated with the FCNC feedback configuration comprises a bit in a header of the FCNC request.

23. The method of claim 18, wherein the FCNC feedback configuration comprises a third indication of a first number of shared feedback resources, wherein each of the shared feedback resources is associated with a different subset of UEs in the plurality of UEs and the first number of shared feedback resources is smaller than a number of UEs in the plurality of UEs, and wherein the first number of shared feedback resources is based on a number of feedback resources available for receiving the feedback from the plurality of UEs and a number of TBs in the subset of the plurality of TBs.

24. The method of claim 23, wherein the first number of shared feedback resources is one of: (1) a largest integer that is smaller than the number of feedback resources available for receiving feedback from the plurality of UEs divided by the number of TBs in the subset of the plurality of TBs, (2) a largest value in a set of values that is smaller than the number of feedback resources available for receiving feedback from the plurality of UEs divided by the number of TBs in the subset of the plurality of TBs, or (3) a threshold value if the number of feedback resources available for receiving feedback from the plurality of UEs divided by the number of TBs in the subset of the plurality of TBs is less than the threshold value.

25. The method of claim 18, wherein the subset of the plurality of TBs comprises one or more TBs for which there is insufficient information to determine that a threshold number of negative acknowledgement (NACK)-to-acknowledgement (ACK) flips is expected based on a transmission of a first NC packet comprising a combination of TBs from the subset of the plurality of TBs and wherein the threshold number of NACK-to-ACK flips is one of a known threshold value, or a lesser of the known threshold value and a value dependent upon a number of bins used to receive the feedback associated with the FCNC request.

26. A method for wireless communication at a user equipment (UE), comprising:
receiving, from a network encoding device, a feedback collection network coding (FCNC) request for a subset of a plurality of transport blocks (TBs) for collecting feedback information regarding the subset of the plurality of TBs, the FCNC request being a network coding (NC) packet comprising a first indication that the NC packet is associated with an FCNC feedback configuration, the FCNC feedback configuration being different from a feedback configuration for NC packets that are not FCNC requests; and
transmitting, to the network encoding device, feedback associated with the FCNC request based on the FCNC feedback configuration.

27. The method of claim 26, wherein the first indication that the NC packet is associated with the FCNC feedback configuration comprises a bit in a header of the FCNC request.

28. The method of claim 26, wherein the FCNC feedback configuration comprises a second indication of a first number of shared feedback resources, wherein each of the shared feedback resources is associated with a different subset of UEs in a plurality of UEs and the first number of shared feedback resources is smaller than a number of UEs in the plurality of UEs, wherein the UE is included in the plurality of UEs.

29. The method of claim 26, further comprising identifying a set of resources for transmitting the feedback associated with the FCNC request based on the FCNC feedback configuration:
identifying a resource pool associated with each TB in the subset of the plurality of TBs; and
identifying a shared feedback resource in each resource pool for transmitting feedback regarding an associated TB in the subset of the plurality of TBs.

30. The method of claim 29, wherein the resource pool associated with each TB is identified based on a packet identifier associated with a corresponding TB, and wherein the shared feedback resource is identified based on one or more of a UE identifier, a communication session identifier, a zone identifier, or a beam identifier.
